(19) United States
(12) Patent Application Publication
(10) Pub. No.: US 2012/0294597 A1
(43) Pub. Date: Nov. 22, 2012

(54) DUAL STATE ASSEMBLY, IMAGE CAPTURING SYSTEM HAVING THE SAME, AND ASSOCIATED METHODS

(76) Inventors: Gal SHABTAY, Tel-Aviv (IL); Ephraim GOLDENBERG, Tel-Aviv (IL); Alan D. KATHMAN, Charlotte, NC (US); W. Hudson WELCH, Charlotte, NC (US); Roman GUTIERREZ, Charlotte, NC (US)

(21) Appl. No.: 13/110,472

(22) Filed: May 18, 2011

(51) Int. Cl. G03B 3/00; B23P 17/00; G03B 9/04

(52) U.S. Cl. 396/75; 396/505; 29/428

(57) ABSTRACT

An assembly for an image capturing device may include a blade configured to pass light without modification when in a first position and, when in a second position, provide one of an aperture blocking a portion of the light, a low power lens, and a transparent film, and an actuator configured to move the blade between the first and second positions.

### BACKGROUND OF THE INVENTION

1. Field of the Invention

Embodiments relate to a dual state assembly, an image capturing system including the same, and associated methods.

2. Description of the Related Art

Imaging capturing systems employed in mobile devices, e.g., digital cameras used in phones, typically have single iris modules having a fixed aperture and, hence, a fixed F number. Most such digital cameras have apertures that provide F numbers between F/2.4 to F/2.8. F numbers in the higher end of this range provide good image resolution and contrast, but have lower performance under low light conditions. F numbers in the lower end of this range provide better performance under low light conditions.

### SUMMARY OF THE INVENTION

Embodiments are therefore directed to a dual state assembly and an image capturing system including the same that substantially overcome one or more of the disadvantages of the related art.

Embodiments are directed to an assembly for an image capturing device. The assembly may include a blade configured to pass light without modification when in a first position and to focus light to a different object distance when in a second position, and an actuator configured to move the blade between the first and second positions.

When in a second position, the blade may provide one of an aperture blocking a portion of the light, a low power lens, and a transparent film.

The actuator may be one of an electromagnetic actuator, an electrostatic actuator, a piezoelectric actuator, a shape memory alloy actuator, and an electrostrictive polymer actuator.

The blade may include a low power lens provided when the blade is in the second position.

The low power lens may be mounted on the blade.

The low power lens and the blade may be made from the same material.

The low power lens and the blade may form a single, integral unit.

The low power lens may have a power of about 2 diopters to about 10 diopters, e.g., about 4 diopters.

The low power lens may be made from a replication material.

The blade may be completely transparent.

The blade may provide an aperture in the second position that blocks some of the light.

The aperture may be a pin-hole, e.g., a pin-hole is in the blade.

The pin-hole may increase an F/# of the lens by a factor of about 1.25 to about 4, e.g., by a factor of about 2.

The blade may provide a transparent film when in the second position.

Embodiments are directed to an image capturing device. The image capturing device may include a detector including a plurality of sensing pixels, an optical system focusing an object onto the detector, and a blade configured to pass light without modification when in a first position and to provide focusing for a different object distance when in a second position.

The image capturing device may also include an actuator moving the blade between the first and second positions. The blade and the actuator may form an assembly and may have any of the details described above.

When in the second position, the blade may be closer to the object than the optical system is to the object.

The blade may be directly on top of the optical system.

The blade may be on a housing for the optical system.

The blade may be within a housing for the optical system.

The optical system may include a first lens and a second lens, the first lens being closer to the object than the second lens is to the object.

The blade may be closer to the object than the first lens is to the object.

The blade may be between the first lens and the second lens.

The blade may be within the optical system when in the second position. The blade within the optical system in the second position may provide a transparent film.

The optical system without the blade may provide an extended depth of field. The extended depth of field may be provided by a lens system including one or more optical elements disposable into at least first and second discrete states.

Embodiments are directed to a method for focusing an image capturing device to different object distances. The method may include providing the image capturing device with a blade configured to pass light without modification when in a first position and to focus light to a different object distance when in a second position and moving the blade between the first and second positions.

When in a second position, the blade may provide one of an aperture blocking a portion of the light, a low power lens, and a transparent film.

Embodiments are directed to a method of forming an assembly for an image capturing device. The method may include forming a blade configured to pass light without modification when in a first position and to focus light to a different object distance when in a second position and securing the blade to an actuator configured to move the blade between the first and second positions.

When in a second position, provide one of an aperture blocking a portion of the light, a low power lens, and a transparent film.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 A illustrates a schematic side view of an image capturing system with a dual state assembly in a first state in accordance with embodiments;

FIG. 1B illustrates a schematic side view of an image capturing system with a dual state assembly in a second state in accordance with embodiments;

FIG. 1C illustrates a schematic side view of an image capturing system with a dual state assembly in a second state in accordance with embodiments;

FIG. 2A illustrates a schematic side view of an image capturing system with a dual state assembly;

FIG. 2B illustrates a top schematic view of the image capturing system of FIG. 2A;

FIG. 2C illustrates a perspective schematic view of a middle snub of the image capturing system of FIG. 2B;

FIG. 3 illustrates side view of stages in a method for making a blade in accordance with embodiments;

FIG. 4 illustrates side view of stages in a method for making a blade in accordance with embodiments;

FIG. 5 illustrates side view of stages in a method for making a blade in accordance with embodiments;

FIGS. 6A and 6B illustrate side views of a method of making a blade in accordance with embodiments;

FIG. 7 is an exploded perspective view of an image capturing device in accordance with embodiments;

FIG. 8 is a schematic perspective view of a computer incorporating an image capturing device in accordance with embodiments; and

FIG. 9 is a schematic perspective view of a computer incorporating an image capturing device in accordance with embodiments.

### DETAILED DESCRIPTION

Embodiments will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions may be exaggerated for clarity of illustration.

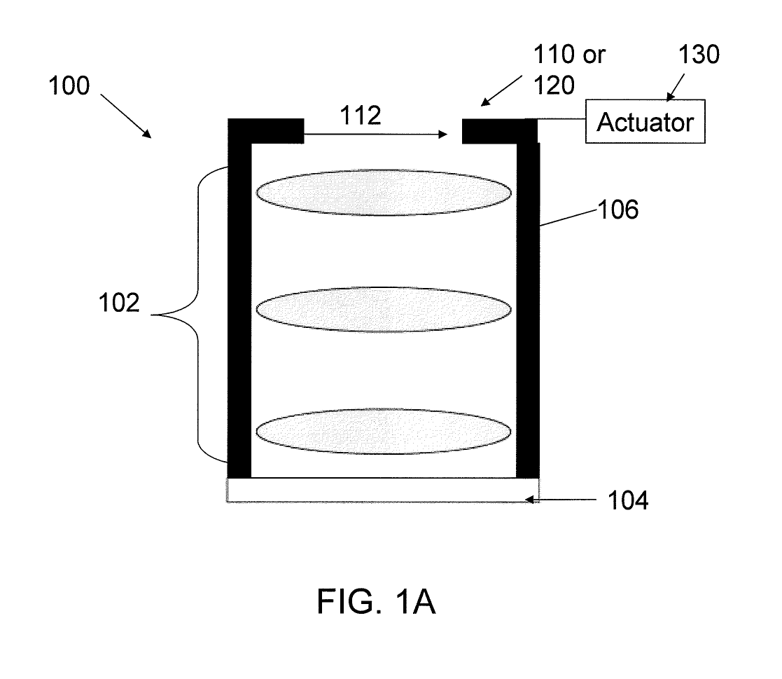

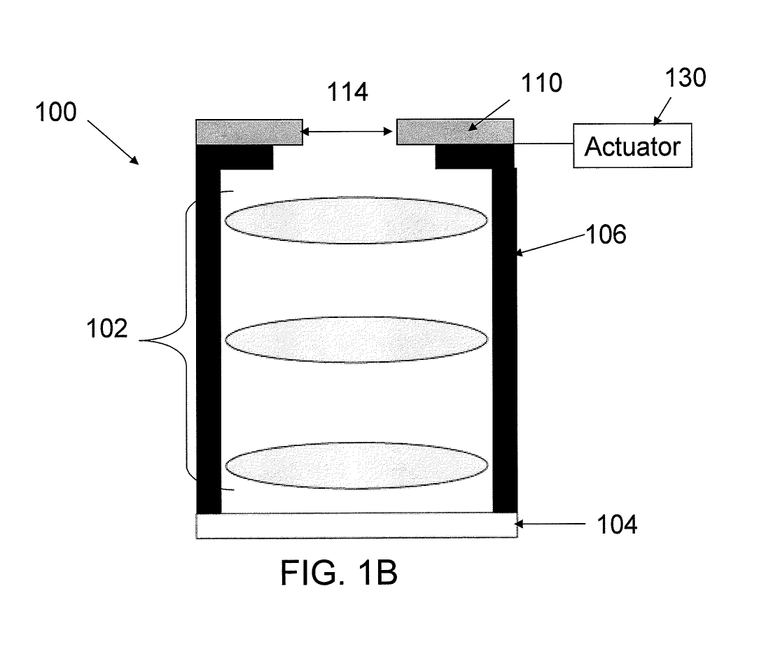

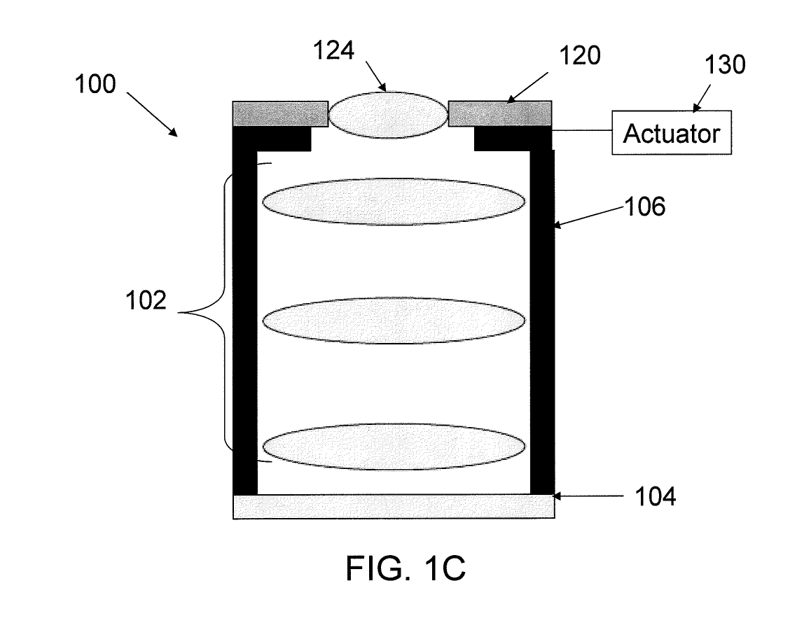

FIG. 1A illustrates an image capturing device 100 including an optical system 102 for focusing an object onto a detector array 104, e.g., a plurality of sensing pixels. The optical system 102 may be housed in a housing 106 that may shield the detector 104 from stray light. A blade 110 may be provided in front of the optical system 102, e.g., on top of the housing 106. An actuator 130 may be provided to control positioning of the blade 110 between a first state and a second state. The actuator 130 may be any suitable actuator, e.g., an electromagnetic actuator, an electrostatic actuator, a piezoelectric actuator, a shape memory alloy actuator, an electrostrictive polymer actuator, and so forth. Examples of suitable actuators may be found in U.S. Pat. No. 7,570,882, entitled “Shutter for Miniature Camera,” and U.S. Pat. No. 7,832,948, entitled “Impluse Actuated MEMS Devices,” the entire contents of both of which are hereby incorporated by reference.

In FIG. 1A, the blade 110 is in the first state in which an open shutter and a large diaphragm 112 is provided for the optical system 102. In other words, light may pass to the optical system 102 without alteration by the blade 110.

FIG. 1B illustrates the blade 110 in the second state in which the blade 110 provides an aperture 114 in front of the optical system 102, e.g., on the top of the housing 106 for the optical system 102. The aperture 114 provides a decreased diaphragm, thereby increasing the depth of the field of the optical system 102. Accordingly, the image capturing device 100 will have two photography modes, a first mode in which the blade 110 is in the first state, i.e. without the aperture 114 in front of the optical system 102, and with a small F/#, and a second mode in which the blade 110 is in a second state, i.e., with the small aperture 114 in front of the optical system 102, and the F/# is large. The user will be able to select one of the camera's two modes according to whether near or far images are to be photographed.

For example, the aperture 114 may be a pin-hole, e.g., a pin-hole in the blade 110. The pin-hole may increase the F/# of the lens by a factor of 1.25 to 4, e.g., 2, i.e., the pin-hole pass about 64% to 6.25% of the light, e.g., about 25% of the light.

FIG. 1C illustrates a blade 120 in accordance with embodiments in a second state. When in the second state, the blade 120 provides a lens 124 that enables the user to photograph very near objects. In the first state, the blade 120 will provide a large diaphragm 112 for the optical system 102, as illustrated in FIG. 1A. The lens 124 may be a low power lens, e.g., having a power of about 2 diopters to about 10 diopters, e.g., about 4 diopters.

This design allows for a system with two-state auto-focus that can capture an image from a near distance (e.g., about 30 cm) to infinity without having a special lens for EDoF. When combined, however, with an EDoF optical system, the DoF range of the shorter distances may be expanded up to 10 cm. This improves the image quality by producing sharp images at both short and long distances. The EDoF optical system makes sure there is no distance (e.g., 40 cm) that is not in focus. As described above, in accordance with embodiments, by using a relatively inexpensive shutter, coverage is provided for both near and far objects according to need, without using an automatic focus lens and with only minimal effect on the optical system's SNR.

The dual state blades 110, 120 allow both low and high F numbers to be realized in a compact camera without complicated movable optics. Using the dual state blades 110, 120 enables the user to enjoy the above mentioned advantages of both low and high f numbers, i.e., normal and macro mode image captures.

For example, in a first or normal mode, as illustrated in FIG. 1A, the blade 110, 120 provides a wide aperture 112, thereby providing a low-F/#, e.g., F/2.4, for the image capturing device 100. The image capturing device 100 in the first mode, having a depth of field, e.g., from 30 cm to infinity, provides advantages, including shorter exposure time, less motion blur, higher resolution, and better well low-light performance (less noise for the same exposure time).

In a second or macro mode, as illustrated in FIGS. 1B or 1C, the blade 110, 120 provides a narrow aperture 114, with or without the low power lens 124, thereby providing a high-F/#, e.g., F/4.8, for the image capturing device 100. Hence, the depth of field for the image capturing device 100 is extended, allowing objects located at closer distances, e.g., within a distance of less than 30 cm, to be imaged. The poorer low light performance in the second mode may be solved by using extra light, e.g., a flash. The second mode might be used, for example, to read business cards, text, barcodes, and so forth.

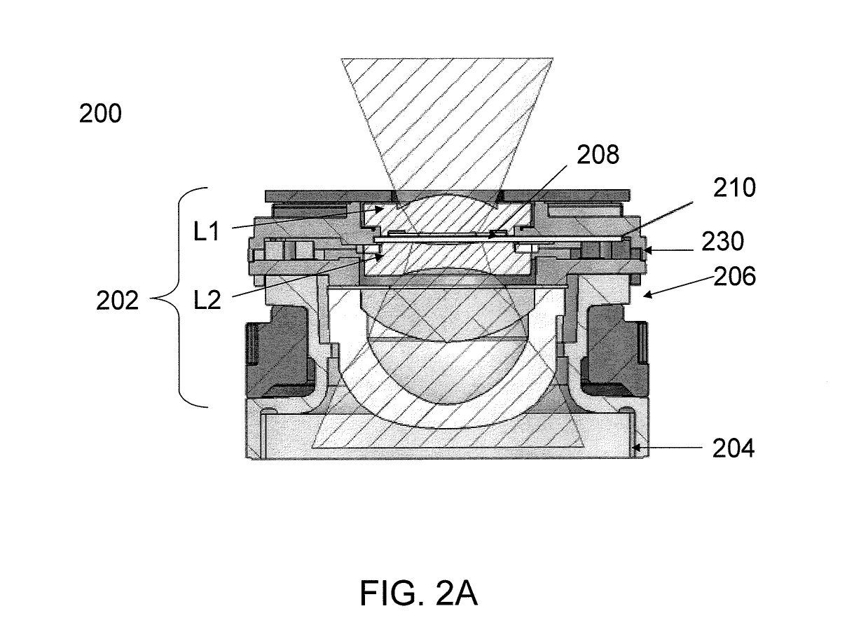

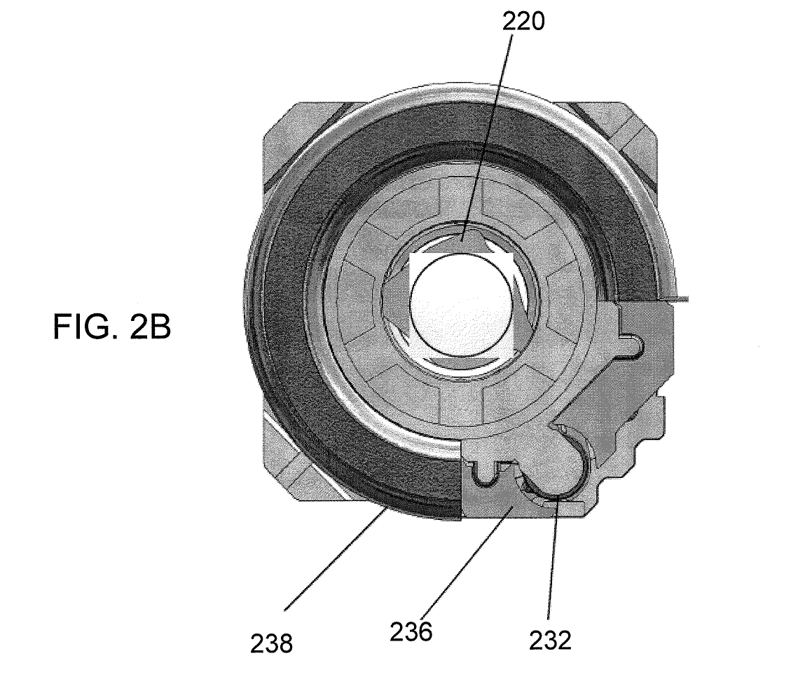

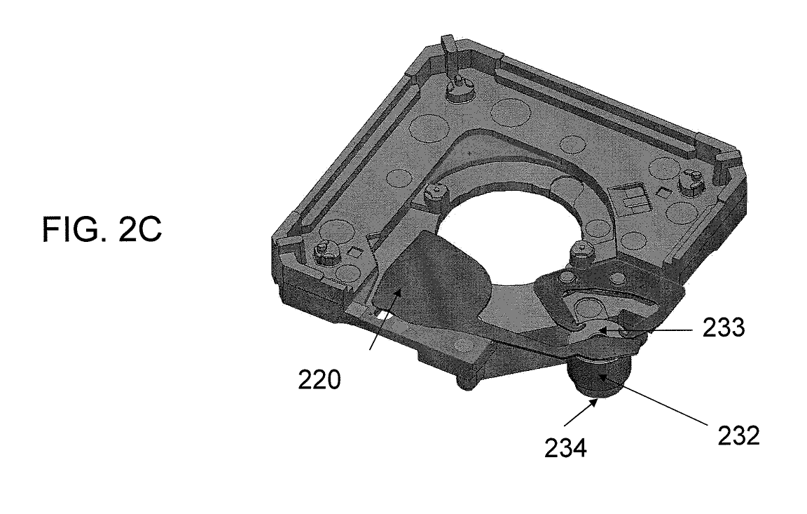

While the above embodiments may be implemented without altering the optical system 102 or the housing 106, an overall height of the image capturing device is increased by the height of the blade 110, 120. As discussed below, with reference to FIGS. 2A to 2C, a blade may be incorporated into an optical system for the image capturing device.

An image capturing system 200 according to embodiments is illustrated in FIGS. 2A to 2C. The image capturing system 200 may include an optical system 202 for focusing an object onto a detector array 204. The optical system 202 may be housed in a housing 206 that may shield the detector array 204 from stray light. A blade 210 may be provided within the optical system 202, e.g., between a first lens substrate L1 and a second lens substrate L2 of the optical system 202.

When the blade 210 is in a first state, as shown in FIG. 2C, only air is in the optical path between the first and second lens substrates. In other words, light may pass to the optical system 202 without alteration by the blade 210, e.g., the image capturing device 200 is focused to infinity.

When the blade 210 is in a second state, as shown in FIGS. 2A and 2B, the blade 210 is in the optical path between the first and second lens substrates L1, L2. In other words, the blade 210 replaces air with a transparent material having a refractive index higher than that of air, effectively increasing a spacing 208 between the lens substrates L1, L2. The degree to which the blade 210 increases the spacing 208 depends on the refractive index of the material and the thickness of the blade 210. For example, when the blade 210 is made of a material having a refractive index of 1.5 and a thickness of 100 pm, the spacing 208 is effectively increased by 50 μm. As the blade 210 may be made of a thickness less than that of the physical spacing 208, the height of the image capturing device may not be increased.

The blade 210 may be just a transparent film cut into the correct shape, resulting in very low cost element. Additionally, the blade 210 may have optical power therein, may include diffractive optical elements, and/or have filtering (color, polarization, and/or intensity).

In order to move the blade 210 between the first and second states, an actuator 230 may be integrated in the housing 206. Referring to FIGS. 2B and 2C, the actuator 230 may include a magnet 232 having a hole 233 therein, a pivot 234, a coil 236, and a core 238. The coil 236 maybe wrapped around the core 238 that guides the magnetic field across the magnet 232. The magnet 232 may be oriented with respect to the flux bar so that the actuator 230 is a bistable actuator that only requires current pulse to switch between the two states (direction of current depends on desired direction of motion). In other words the N-S direction of the magnet 232 may be roughly perpendicular to a line connecting ends of the magnetic core 238.

The blade 210 is attached to the magnet 232. Plastic parts may be used to cage the blade 210 and limit its motion to the desired trajectory. Power consumption is really low, since a current is only applied to coil 238 for ˜5 ms to switch the blade 210 between the two states.

When the blade 120, 210 is to have optical power therein, surface(s) providing optical power may be a suitable lens mounted on the blade 120, 210, in which the blade 120, 210 would itself be transparent and may or may not be the same material as the lens, or a suitable lens dropped in a passage in the blade 120, 210. Alternatively, surface(s) providing optical power may be integral with the blade 120, 210 itself. Example methods of making an integral blade are provided below. Before or after singulation, any of the blades may be secured to the actuator 130 or 230.

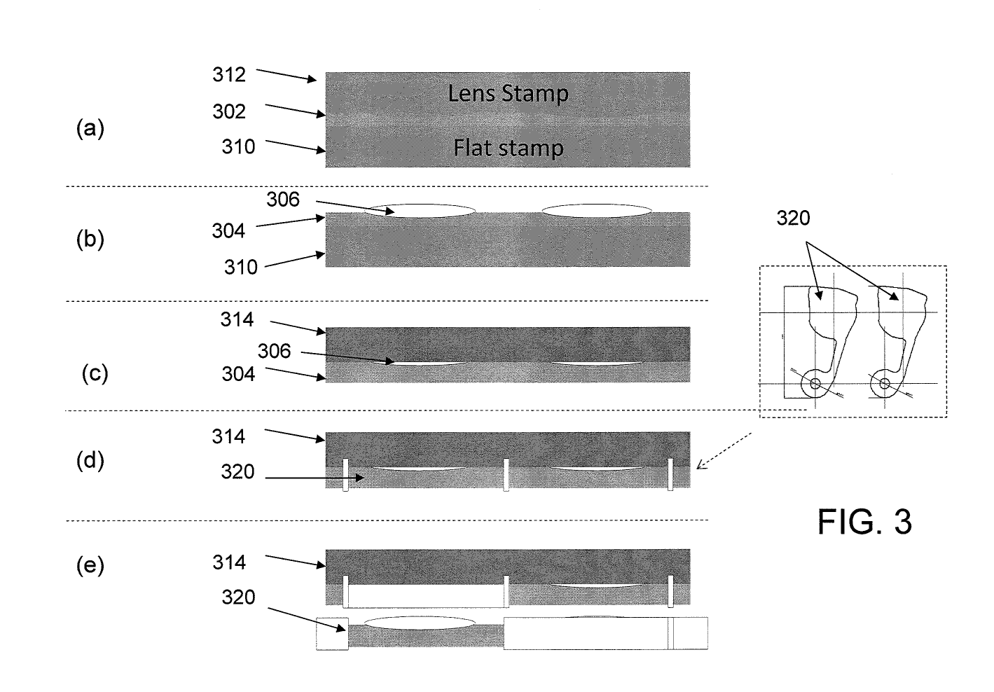

FIG. 3 illustrates stages in a method of making a blade 320 having power therein in accordance with embodiments. As shown in FIG. 3(a), a replication material 302 may be provided between a flat stamp 310 and a lens stamp 312. After the replication material 302 is cured, the lens stamp 312 is removed, leaving the stamped material 304 having a refractive surface 306 on the flat stamp 310, as shown in FIG. 3(b). The stamped material 304 may be transferred from the flat stamp 310 to a singulation tape 314, as shown in FIG. 3(c). The stamped material 304 may then be processed, e.g., laser cut, to define individual blades 320, as shown in FIG. 3(d). A plan view of the individual blades 320 is shown in the inset from FIG. 3(d). These individual blades 320 may then be removed from the singulation tape 314, as shown in FIG. 3(e).

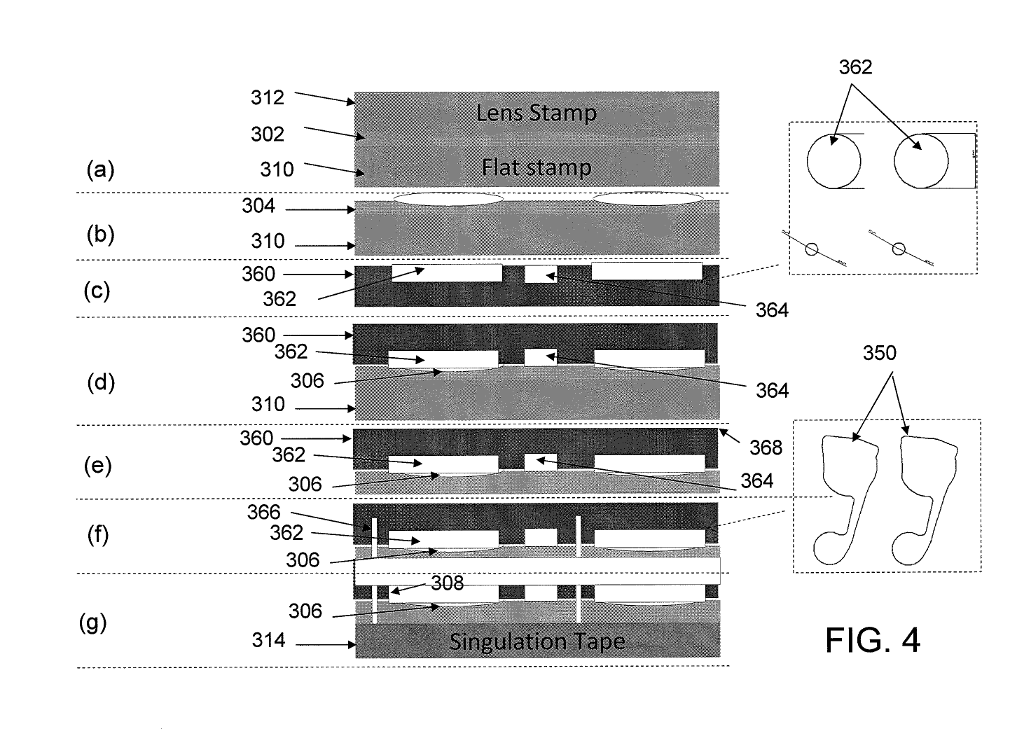

FIG. 4 illustrates stages in a method of making a blade 350 having power therein in accordance with embodiments. As shown in FIG. 4(a), a replication material 302 may be provided between a flat stamp 310 and a lens stamp 312. After the replication material 302 is cured, the lens stamp 312 is removed, leaving the stamped material 304 having refractive surfaces 306 on the flat stamp 310, as shown in FIG. 4(b).

Meanwhile, a substrate 360, e.g., a silicon substrate, having corresponding notches 362 and separation notches 364 formed therein may be prepared, as illustrated in FIG. 4(c). For example, notches 362, 364 may be formed in the substrate 360 by blasting. A plan view of notches 362 is shown in the inset from FIG. 4(c).

The stamped material 304 may be transferred from the flat stamp 310 to the substrate 360. The refractive surfaces 306 in the stamped material 304 and the corresponding notches 362 in the substrate 360 are aligned, while the separation notches 364 are provided between adjacent lenses 306, as shown in FIG. 4(d). Then, the flat stamp 310 may be removed, as shown in FIG. 4(e).

The stamped material 304 and the substrate 360 may then be processed, e.g., laser cut, to define individual blades 350, defined by grooves 366, which are deeper than the notches 362, 364, as shown in FIG. 4(f). A plan view of individual blades 350 is shown in the inset from FIG. 4(f). A surface 368 of the substrate 360 opposite the notches 362, 364, may be removed, e.g., ground, to form individual blades 350 including a lens 306 and a standoff 308. The stamped material 304 may be provided on singulation tape 314 during this process, as shown in FIG. 4(g), and then removed from the singulation tape 314.

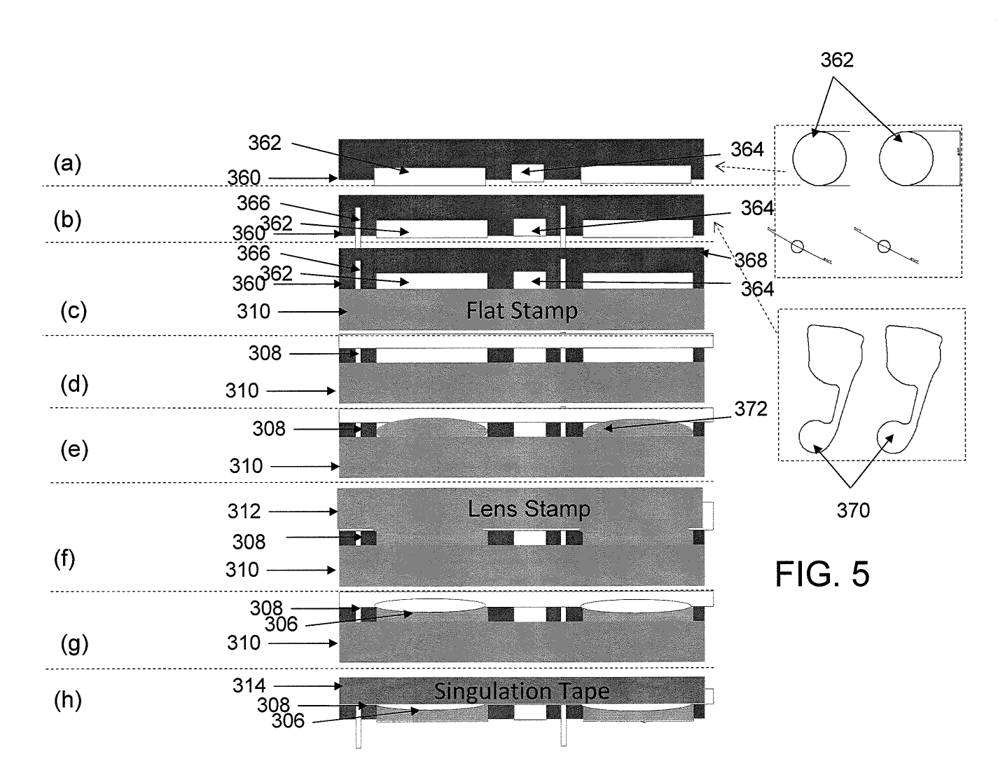

FIG. 5 illustrates stages in a method of making a blade 370 having power therein in accordance with embodiments. As shown in FIG. 5(a), the substrate 360, e.g., a silicon substrate, having corresponding notches 362 and separation notches 364 formed therein may be prepared. For example, notches 362, 364 may be formed in the substrate 360 by sand blasting. A plan view of notches 362 is shown in the inset from FIG. 5(a).

The substrate 360 may then be processed, e.g., laser cut, to provide grooves 366 between notches 364 and 362, as shown in FIG. 5(b). The grooves 366 are deeper than the notches 364, 362 and are used to define separate individual blades 370. A plan view of individual blades 370 is shown in the inset from FIG. 5(b).

The substrate 360 is then attached to the flat stamp 310, as shown in FIG. 5(c). A surface 368 of the substrate 360 opposite the notches 362, 364, may be removed, e.g., ground, such that only standoffs 308 remain on the flat stamp 310, as shown in FIG. 5(d).

Then, as shown in FIG. 5(e), a replication material 372 may be dispensed into the corresponding notches 362. The lens stamp 312 may then be brought into contact with the replication material 372, as shown in FIG. 5(f). Once the replication material 372 is cured, the lens stamp 312 may be removed, leaving lenses 306 and standoffs 308 on the flat stamp 310, as shown in FIG. 5(g), which may, in turn, be transferred to the singulation tape 314 from which individual blades 370 may be picked off, as shown in FIG. 5(h).

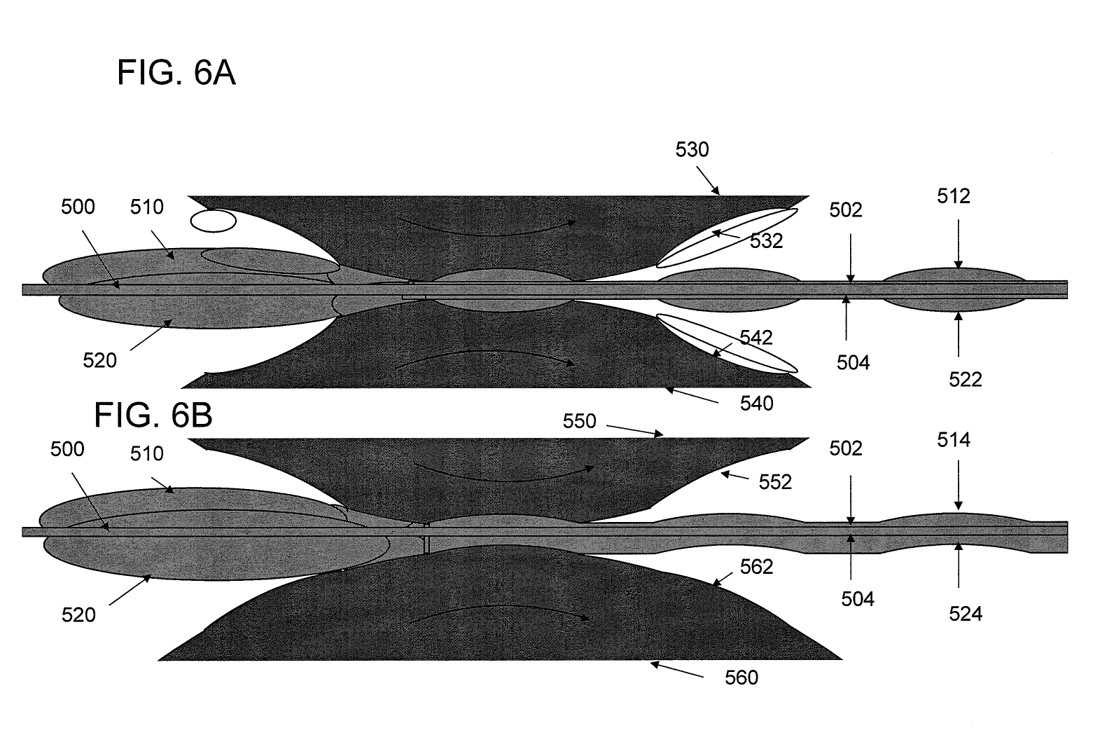

FIG. 6A and 6B illustrate a method of forming a double sided optical element for a blade in accordance with embodiments. In particular, FIGS. 6A and 6B illustrate roll-to-roll lens fabrication, in which a carrier film 500 having replication material 510, 520 on both upper and lower surfaces 502, 504 thereof is static and lens surfaces are formed thereon by rolling stamps 530, 540 or 550, 560 (only partial views of which are shown for compactness and ease of illustration) having a negative of the lens surface to be formed in the replication material 510, 520. The replication materials 510, 520 may be the same or different. In the particular examples illustrated in FIGS. 6A and 6B, the rolling stamp 530 includes a concave mold 532 that stamps a convex surface 512 in the replication material 510; the rolling stamp 540 includes a concave mold 542 that stamps a convex surface 522 in the replication material 520; the rolling stamp 550 includes a concave mold 552 that stamps a convex surface 514 in the replication material 510; and the rolling stamp 560 includes a convex mold 562 that stamps a concave surface 524 in the replication material 520. The carrier film 500 with the lens surfaces on both upper and lower surfaces thereof may be singulated into a desired blade shape.

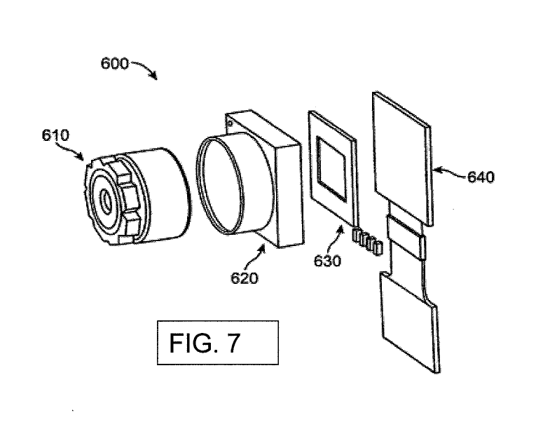

FIG. 7 illustrates an exploded view of a digital camera 600 in which a dual state assembly in accordance with embodiments may be employed. As seen therein, the digital camera 600 may include a lens system 610 to be secured to a lens holder 620, which, in turn, may be secured to a sensor 630. Finally, the entire assembly may be secured to electronics 640. As discussed above, a dual state assembly including a blade having little or no power may be deployed within the lens system 610 or on top of the lens system 610.

Portions of the preceding disclosure have been couched in terms of an image capturing device taking the form of a digital still camera (again, DSC). While such a DSC may be a stand-alone camera, it could also be a component of a larger system for which a still camera represents a secondary functionality (“still-camera-ancillary”). Examples of stand-alone cameras include a point-and-shoot-type of camera, a single-lens-reflex type of camera, a web cam type of camera, a surveillance-type of camera, a probe-type camera; etc. Examples of still-camera-ancillary devices include a telephone (e.g., wireless that also includes radio telephony circuitry), a personal data assistant device, a personal computer (e.g., also including a processor and a storage device), an MP3 player, a kiosk, an automated teller machine, a probe, a video camera; etc.

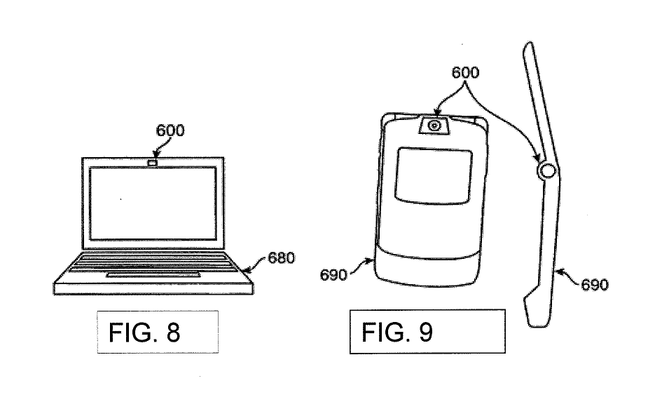

FIG. 8 illustrates a perspective view of a computer 680 having the digital camera 600 integrated therein. FIG. 9 illustrates a front and side view of a mobile telephone 690 having the digital camera 600 integrated therein. Of course, the digital camera 600 may be integrated at other locations than those shown.

Thus, in accordance with embodiments, a blade may be employed on top of or within an optical system to extend a depth of field of an image capturing device.

As used herein, the term “and/or” includes any and all combinations of one or more of the associated listed items. Further, although terms such as “first,” “second,” “third,” etc., may be used herein to describe various elements, components, regions, layers and/or sections, these elements, components, regions, layers and/or sections should not be limited by these terms. These terms are only used to distinguish one element, component, region, layer and/or section from another. Thus, a first element, component, region, layer and/or section could be termed a second element, component, region, layer and/or section without departing from the teachings of the embodiments described herein.

Spatially relative terms, such as “beneath,” “below,” “lower,” “above,” “upper,” etc., may be used herein for ease of description to describe the relationship of one element or feature to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the singular forms “a,” “an” and “the” are intended to include the plural forms as well, unless the context clearly indicates otherwise. It will be further understood that the terms “comprises,” “comprising,” “includes,” and “including” specify the presence of stated features, integers, steps, operations, elements, components, etc., but do not preclude the presence or addition thereto of one or more other features, integers, steps, operations, elements, components, groups, etc.

Embodiments of the present invention have been disclosed herein and, although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

What is claimed is:

1. An assembly for an image capturing device, the assembly comprising:
a blade configured to pass light without modification when in a first position and, when in a second position, provide one of an aperture blocking a portion of the light, a low power lens, and a transparent film; and
an actuator configured to move the blade between the first and second positions.

2. The assembly as claimed in claim 1, wherein the actuator is one of an electromagnetic actuator, an electrostatic actuator, a piezoelectric actuator, a shape memory alloy actuator, and an electrostrictive polymer actuator.

3. The assembly as claimed in claim 1, wherein the blade includes a pin-hole when in the second position.

4. The assembly as claimed in claim 3, wherein the pin-hole is in the blade.

5. The assembly as claimed in claim 4, wherein the pin-hole increases an F/# of the lens by a factor of about 1.25 to about 4.

6. The assembly as claimed in claim 5, wherein the pin-hole increases the F/# of the lens by a factor of about 2.

7. The assembly as claimed in claim 1, wherein the low power lens is mounted on the blade.

8. The assembly as claimed in claim 7, wherein the low power lens and the blade are made from a same material.

9. The assembly as claimed in claim 8, wherein the low power lens and the blade form a single, integral unit.

10. The assembly as claimed in claim 7, wherein the low power lens has a power of about 2 diopters to about 10 diopters.

11. The assembly as claimed in claim 10, wherein the low power lens has a power of about 4 diopters.

12. The assembly as claimed in claim 7, wherein the low power lens is made from a replication material.

13. The assembly as claimed in claim 7, wherein the blade is completely transparent.

14. The assembly as claimed in claim 1, wherein the transparent film is the blade.

15. The assembly as claimed in claim 14, wherein the blade is completely transparent.

16. An image capturing device, comprising:
a detector including a plurality of sensing pixels;
an optical system focusing an object onto the detector; and
an assembly as claimed in claim 1.

17. The image capturing device as claimed in claim 16, wherein, when in the second position, the blade is closer to the object than the optical system is to the object.

18. The image capturing device as claimed in claim 17, wherein the blade is directly on top of the optical system.

19. The image capturing device as claimed in claim 17, wherein the blade is on a housing for the optical system.

20. The image capturing device as claimed in claim 17, wherein the blade is within a housing for the optical system.

21. The image capturing device as claimed in claim 17, wherein:
the optical system includes a first lens and a second lens, the first lens being closer to the object than the second lens is to the object,
the blade includes the transparent film, and
the blade is between the first lens and the second lens.

22. The image capturing device as claimed in claim 21, wherein the blade is within the optical system when in the second position.

23. A method for focusing an image capturing device to different object distances, the method comprising:
providing the image capturing device with a blade configured to pass light without modification when in a first position and, when in a second position, provide one of an aperture blocking a portion of the light, a low power lens, and a transparent film; and
moving the blade between the first and second positions.

24. A method of forming an assembly for an image capturing device, the method comprising:
forming a blade configured to pass light without modification when in a first position and, when in a second position, provide one of an aperture blocking a portion of the light, a low power lens, and a transparent film; and
securing the blade to an actuator configured to move the blade between the first and second positions.
